(19) United States
(12) Patent Application Publication
(10) Pub. No.: US 2025/0083979 A1
(43) Pub. Date: Mar. 13, 2025

(54) MEMBRANE PROCESS FOR WASTEWATER RECYCLING AND SOLVENT RECOVERY

(71) Applicant: Aquatech International LLC, Canonsburg, PA (US)

(72) Inventors: Ravi Chidambaran, Canonsburg, PA (US); Narendra Singh Bisht, Maharashtra (IN); Nitin Chandan, Maharashtra (IN); D.V.R. Seshagiri Rao, Maharashtra (IN); Lalit W. Kumbhare, Maharashtra (IN)

(21) Appl. No.: 18/827,266

(22) Filed: Sep. 6, 2024

(30) Foreign Application Priority Data
Sep. 7, 2023 (IN) 202311060244

(51) Int. Cl. C02F 1/44

(52) U.S. Cl. CPC C02F 1/441; C02F 2209/06

(57) ABSTRACT

Embodiments provide methods for separation of solvents from water using reverse osmosis membranes. The recovered water and/or recovered solvents may be recycled into a process or otherwise diverted for beneficial use.

### CROSS-REFERENCE TO RELATED APPLICATIONS

This application claims priority to Indian Application No. 202311060244, filed on Sep. 7, 2023. That application is incorporated by reference herein.

### BACKGROUND OF THE INVENTION

### Field of the Invention

Embodiments relate to treatment of wastewater through a reverse osmosis (RO) process.

### Background of the Related Art

Environmental protection becomes more and more critical and important with time. Although the goal of environmental-oriented processes is to prevent waste generation, in many cases, it is unavoidable.

A typical example of this is the chemical industry, which uses various solvents to carry out chemical reactions. The excess solvents used in the chemical process may get mixed with the effluent and become part of the water pollution, which is then treated by conventional methods, in which solvents are destroyed either biologically or chemically. In connection with the circular economy and end-of-pipe treatment methods, it is important to take into account potential recoverable materials and their recycling and reuse.

Wastewater treatment methods can be categorised into three classes: biological, physical, and chemical processes. As regards water soluble organic contamination, we usually talk about biological wastewater treatment processes, which can be further combined with mechanical or physical operations.

Though the biological process has many advantages, it is typically a waste treatment process in which the recovery of organic compounds is impossible, as they disintegrate while being treated. On the other hand, it is not always applicable due to its operational limitations in the case of wastewater with high organic content. Such solvents also create toxicity for bacteria and it becomes difficult to grow Biomass for efficient digestion of COD or ammonia. Sometimes when a small volume of such solvents is mixed in a large volume of wastewater, it makes the process of treatment of entire water difficult and expensive due to toxicity caused by these solvents to biomass growth.

Another method of incineration is also not possible as it excludes the possibility of recycling, is typically a polluting process, and is energy intensive for aqueous waste. It is therefore the least preferable solution.

Therefore, there is a need for other water treatment alternatives to be considered, e.g., the physicochemical method, which can be a possible option to keep the properties of organic compounds or solvents intact after separation and increase the possibility of recycling. Another option for distillation for the entire flow will also become cost prohibitive as it would involve a phase change of water which would need steam. However, a concentrated stream of such solvents after removing 90-95% water can go through a distillation process to recover the solvent. The present invention devises a process of physical separation by using a membrane based reverse osmosis (RO) process for the separation of organic solvents from water and further purification of those organic solvents.

### BRIEF SUMMARY OF THE INVENTION

Embodiments of the invention may provide, but are not required to provide, one or more of the following aspects:
1. Separation of organic solvents from water.
2. Application of a membrane process as a separation method for the treatment of solvent-rich wastewater.
3. RO membrane process operation and in multiple stages to achieve effective treatment.
4. An operationally friendly and economical method for the separation of solvent and water.

Embodiments as presented herein may provide an innovative method for the treatment of solvent rich wastewater through reverse osmosis (RO) membrane processing, recovery, and reuse or recycling of maximum water with removal of solvent. This might include, for example, treatment and recovery from solvent rich wastewater with simultaneous concentration of solvent by application of membrane based reverse osmosis (i.e. RO process in solvent rich wastewater).

N,N-dimethylacetamide (DMAC), dimethylformamide (DMF), N-methyl-2-pyrrolidone (NMP), isopropyl alcohol (IPA), acetone, methyl chloride, chloroform, ethyl acetate, etc. are strong polar solvents. These solvents are highly soluble in water and are widely utilized in the manufacturing of film, fibers, and coatings. Some surveys reveal that human exposure to the above solvents leads to liver damage, skin irritation, headaches, loss of appetite, and fatigue. Consequently, the discharge of solvent-rich wastewater can cause serious environmental pollution and harm to human health due to its typically high concentration.

Conventionally, biological processes are applied for the removal of solvent from wastewater water, and it can be degraded either anaerobically or aerobically, which can remove biologically attached COD. However, biological operations would be challenging due to the high Total Kjeldahl Nitrogen (TKN) values in some of the solvents, which further get converted to ammonia during biological degradation and further create toxicity. This results in frequent destabilization of the system. Moreover, there is a need for a specific bacteriological culture to break down the organic carbon as per the structural arrangement. Maintaining a specific culture is quite a challenging job, as shock loading or toxicity may destroy the culture.

Therefore, there is a need to come up with a technology that can perform the separation of solvent and water physically, and the solvents can be concentrated, which can be further extracted in pure form or a small stream of concentrated solvent can be taken for further treatment. Separation through reverse osmosis seems to have the potential to resolve the issue of the separation of solvents from water.

Reverse osmosis has developed greatly in recent decades and has progressed from an emerging technology to a combined, efficient, and competitive process. Reverse osmosis consists of separating the solvent in a concentrated solution that passes through a semipermeable membrane by applying pressure that must be greater than the osmotic pressure. The typical occurrence of reverse osmosis is shown in FIG. 1A.

The RO treatment process is especially attractive due to the high selectivity of the membrane, which allows pure water to pass while the small ions and molecules dissolved in the water can hardly pass. This makes the technology interesting for a wide variety of applications, including but not limited to desalinating sea water, treating liquid effluent, and purifying water for the food and pharmaceutical industries.

There are various parameters that play a key role in the rejection of organic molecules through the RO membrane. Molecular weight is a generally accepted size parameter used to explain the rejection; however, it does not consider the geometry or shape of the molecule.

Solute radius seems to be a better parameter than molecular weight while predicting the rejection of small molecular weight compounds. RO membranes give better rejection of larger molecules. Charge plays an important role in the rejection of solutes through the RO membrane. Generally, thin-film composites have a slight negative charge to increase salt rejection and minimise fouling. The charge of the membrane and solute depend on feed water chemistry, including pH and solute concentrations. It is understood that charged organics experience better rejection than neutral organic compounds.

Embodiments reported herein use RO technology for the separation of organic solvents that are miscible in water. Embodiments provide directions for the separation of low-molecular-weight organic solvents from wastewater produced in the manufacturing industry.

Embodiments may provide multiple RO membrane units connected in series. Each RO unit produces a permeate and reject stream. The permeate gets diluted after each stage, while the reject gets concentrated. The reject is sent back and mixed with the feed of the preceding RO unit, and permeate becomes feed for the next stage.

In this a concentrated solvent stream and a water stream with minimum solvent or solvent free stream are generated. The concentrated reject will come out of the first stage, and diluted water will come from the final stage.

The diluted water can be recycled back into the process. In some embodiments the diluted water is recycled back into the original process after passing through an activated carbon filter (ACF) for polishing, while the concentrated reject is sent for further treatment through advanced vacuum membrane distillation (AVMD, as described in U.S. Pat. No. 11,434,150 B2, which is incorporated by reference herein), followed by agitated thin film dryer (ATFD) processes. The distillate of both AVMD and ATFD are further sent to multi stage distillation or pervaporation for solvent recovery. The solids are discharged from the concentrate stream of ATFD. An embodiment is shown in FIG. 1B and FIG. 1C.

### DESCRIPTION OF THE FIGURES

FIG. 1A shows a typical reverse osmosis array.

FIG. 1B and FIG. 1C show a process flow diagram for a series of RO units according to an embodiment of the invention.

FIG. 2A shows RO feed COD for Experiment 1.

FIG. 2B shows RO reject COD for Experiment 1.

FIG. 2C shows RO Permeate COD for Experiment 1.

FIG. 2D shows overall COD reduction for Experiment 1.

FIG. 3A shows RO feed COD for Experiment 2.

FIG. 3B shows RO reject COD for Experiment 2.

FIG. 3C shows RO permeate COD for Experiment 2.

FIG. 3D overall COD reduction for Experiment 2.

FIG. 4A shows RO-1 unit performance for COD removal.

FIG. 4B shows a trend of COD reduction through RO-2 unit.

FIG. 4C shows a trend of COD for the RO-3 unit.

FIG. 4D shows a trend of COD for the RO-4 unit.

FIG. 4E shows a trend of COD for the RO-5 unit.

### DETAILED DESCRIPTION OF PRESENT INVENTION

The present invention utilizes the RO membrane process as a separation methodology for the treatment of solvent-rich wastewater. This low molecular-weight solvent can be efficiently separated from wastewater by this process, and treated water can be reused for further use. The number of stages will depend on nature of the soluble solvent its molecular weight. The solvent from concentrated reject can be extracted through other treatment processes like pervaporation, distillation, etc.

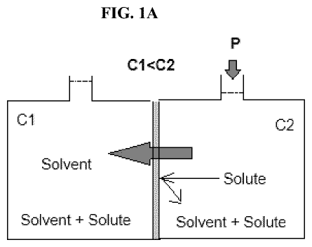

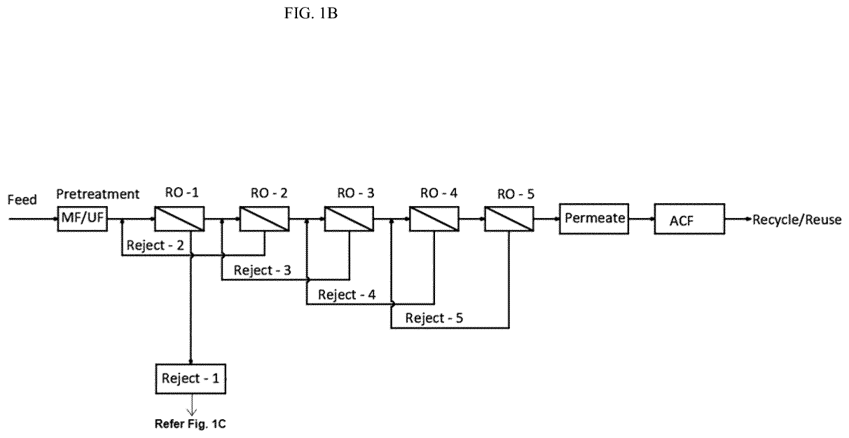

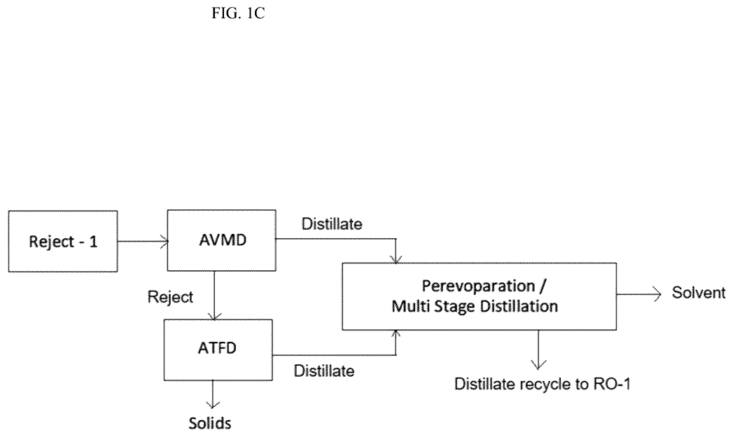

In the invented process, as shown in FIG. 1B, RO units were connected in series in at least 2 stages, most preferably in 4-6 stages, and not more than 10 stages. As per the flow scheme in FIG. 1B, feed wastewater enters first to the pre-treatment step where it passes through an MF/UF unit. This is to remove fine suspended solids, and it typically achieves a silt density index (SDI) of less than 5, more preferably less than 3.

The pre-treated water then enters to the RO-1 unit, where it produces two streams: reject and permeate. In the next stage, the permeate from the RO-1 becomes the feed for the second RO unit (the RO-2 unit). Further permeate of the RO-2 becomes feed for the third, the RO-3, and the reject of the RO-2 is recycled back to the RO-1 feed again. In this way, as the number of stages increase the reject of each stage is recycled to the previous RO stage. The use of this scheme allows all stages of the RO membrane to be operated at similar recovery rates and at the same level of percentage rejection.

The concentration of permeate/feed organics gets diluted in each stage, and concentrated water accumulates in the feed tank. The final concentrated water is removed from the first-stage RO element as a reject and final recovered water is collected from the last stage permeate. Additional treatment of highly concentrated water can be done based on further application.

One of the main expected advantages of this process is the liquid stream does not go through a phase change, so there is no energy consumption related to a phase change. Moreover, after the first stage where most of the salts are removed there is hardly any osmotic pressure to overcome. That means that energy consumption reduces progressively in each stage, and there is an opportunity to increase the flux. The energy consumption in this process is about an order of magnitude lower than distillation for a similar volume of water. This makes it possible to carry out the process of diluting solvent streams and recovering 90-95% of reusable water. This also makes the balance concentrated stream available for solvent recovery through distillation.

A typical embodiment may provide a process for removing a solvent from water, comprising (a) pretreating a feed water containing a solvent in at least one of an ultrafiltration membrane, microfiltration membrane, or nanofiltration membrane; (b) passing the feed water into a first reverse osmosis membrane water purification unit, and creating a first concentrated reject stream comprising the solvent and a first water permeate stream; (c) recycling the first concentrated solvent stream into the feed stream; (d) passing the first water permeate stream to a plurality of reverse osmosis membrane water purification units in a series, where each reverse osmosis membrane water purification unit in the series passes a water permeate stream to a successive feedwater for the next reverse osmosis membrane water purification unit in the series and passes a concentrated reject stream comprising solvent to a feed stream for the prior reverse osmosis membrane; (e) from a final reverse osmosis membrane water purification unit in the series, passing a final water permeate stream for at least one of collection or beneficial use; (f) from the first reverse osmosis membrane water purification unit, purging the first concentrated reject stream; (g) processing the purged first concentrated stream by at least one of advanced vacuum membrane distillation and agitated thin film drying and multi stage distillation or pervaporation as shown in FIG. 1C; (h) recovering solvent from the processed first concentrated reject stream for at least one of collection or beneficial use.

Methods as reported herein may remove a variety of solvents. In some embodiments the solvent has a molecular weight above 50, above 100, or above 200. In some embodiments, the solvent is an organic solvent. Exemplary organic solvents that may be separated from feed water include, for example, but are not limited to, N,N-dimethylacetamide, dimethylformamide, N-methyl-2-pyrrolidone, isopropyl alcohol, acetone, methyl chloride, chloroform, ethyl acetate, and combinations thereof.

In some embodiments each reverse osmosis membrane water purification unit is operated at a pH between 7 and 10. The separate reverse osmosis membrane water purification units may all be operated at the same pH, all be operated at different pH, or may have some at the same pH and others at a different pH or pHs. The pH may increase or decrease in successive unit.

The feed water may be maintained at a pH between 9 and 10. In other embodiments the pH may be maintained between 8 and 11. In still further embodiments the feed water pH may be maintained between 9.0 and 9.5 or between 9.5 and 10.0.

The further processing of the reject stream that includes the solvent may lead to zero liquid discharge. That is, the solvent that is discharged may be free or essentially free of water. In some embodiments the solvent volume has been reduced by a factor of 20 or more relative to the original volume. This allows solvent recovery through distillation with minimal energy expenditure.

Once the feed water is free or essentially free of solvent, the feed water may be recovered, and it may be put to beneficial use. In some embodiments the essentially solvent-free feed water is put to further beneficial use. In some embodiments that beneficial use includes directly recycling the feed water to the original process where the feed water originally became mixed with the type of solvent that was removed.

### EXAMPLES

Two sets of experiments were conducted using bench-scale reverse osmosis membranes. In one of the experiments, a brackish water reverse osmosis (BWRO) membrane was used, while in another trial, a sea water reverse osmosis (SWRO) membrane was used. In particular, the test was conducted using spiral would membranes from Dow. These two experiments were done at different operational conditions based on the feed water characteristics and membrane being used. The flow scheme applied in the testing is shown in FIG. 1B.

A high-pressure centrifugal pump was used to pass solvent-rich wastewater through RO elements. Pressure, temperature, and permeate flow were continually monitored. One of the experiments was conducted by simulation of feed water by addition of a low molecular weight organic solvent to water, whereas in another experiment, actual water was collected from a manufacturing industry for the trial.

The performance of the system was monitored by analysing COD values across each stage. COD analysis was done as per the standard open reflux method. Feed, permeate, and reject pH were measured using a table top pH meter. Pressure across the RO system was checked continually to monitor fouling of the RO element. Experimental conditions for the trials are shown in Table 1.

TABLE 1
Experimental conditions

| | | Value | |
|---|---|---|---|
| Particular | Unit | Experiment-1 | Experiment-2 |
| Feed source | | Simulated | Actual effluent |
| | | water | from membrane |
| | | | manufacturing |
| | | | industry |
| Type of RO | | BWRO/SWRO | BWRO |
| membrane used | | | |
| Maximum feed pressure | Kg/cm2 | 17 | 4.0 |
| Water Recovery | % | >90 | >90 |
| Operating Flux | lmh | 30 | 10-20 |
| Operating temperature | ° C. | 25 | 25 |

### Results

### Experiment-1

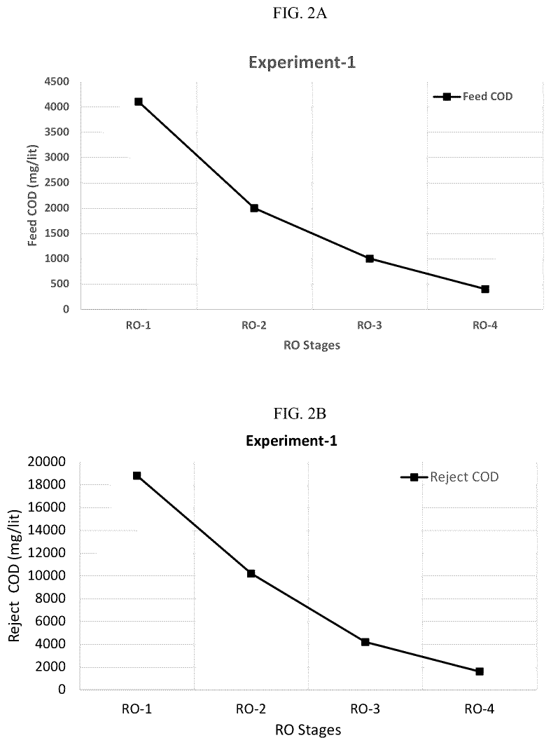

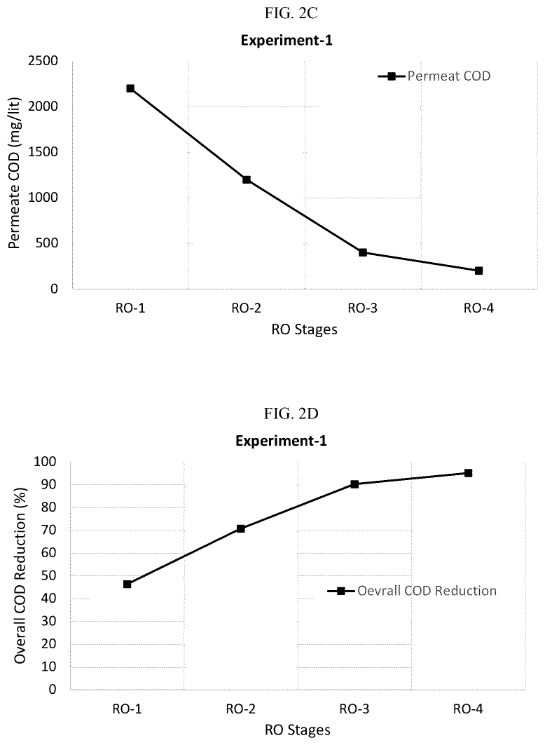

In this experiment, water was simulated in the lab with NaCl water (100 ppm) and isopropyl alcohol (IPA) solution (2000 ppm). Its COD was observed at 4200 ppm. The result of simulated water is shown in Table 2. This simulated water was tested with both BWRO and SWRO membranes. In the case of BWRO membrane, testing was done at 8 kg/cm2 pressure, while SWRO membrane was tested at 17 kg/cm2 feed pressure. Each RO membrane was operated at least two-pass, more preferably 5-pass and not more than 6 passes. Each stage was observed to show 30% COD reduction, though this is not limiting of embodiments of the invention, which may show 40% reduction or not less than 70% COD reduction. Table 3 shows COD data for feed, reject, and permeate, and FIGS. 2A, 2B, 2C and 2D show the trend of feed COD, reject COD, permeate COD and overall COD reduction respectively through RO system.

TABLE 2
Feed water Characteristics of experiment-1

| SN | Parameter | UOM | Value |
|---|---|---|---|
| 1 | pH | — | 6.8 |
| 2 | Conductivity | μS/cm | 208 |
| 3 | Total Dissolved Solids (TDS) | mg/l | 100 |
| 4 | Chemical Oxygen Demand (COD) | mg/l | 4200 |
| 5 | Total Organic Carbon (TOC) | mg/l | 1038 |
| 6 | Isopropyl alcohol (IPA) | mg/l | 2000 |

TABLE 3
COD data of experiment-1

| | COD analysis data (mg/L) | | | | |
|---|---|---|---|---|---|
| Treatment | | | | Reduction across | Overall |
| pass | Feed | Reject | Permeate | each stage | Reduction |
| RO-1 | 4100 | 18800 | 2200 | 46% | — |
| RO-2 | 2000 | 10200 | 1200 | 40% | 70.7% |
| RO-3 | 1000 | 4200 | 400 | 60% | 90.2% |
| RO-4 | 400 | 2000 | 200 | 50% | 95.10% |

As shown in Table 3 and FIGS. 2A, 2B, 2C, and 2D, there is a consistent reduction in COD across each stage. Therefore, after each stage, permeate COD gets reduced, and the overall COD reduction across the system was observed to be >95%. This COD result indicates >95% removal of IPA from the treated water. As the most concentrated water accumulated at the feed tank, the first stage RO reject water had a high COD concentration. This concentrated COD can be further treated with suitable technology for the separation of solvent.

### Experiment-2

Actual wastewater was used for experiment 2, whose characteristics are shown in Table 4. Water was collected from the manufacturing industry. This manufacturing process uses different types of organic solvents for the formulation. This industry uses solvents with highly nitrogenous compounds like dimethylacetamide (DMAC) alternatively dimethylformamide (DMF). The solvent used in the manufacturing process was readily biodegradable; however, the presence of high TKN, which further converts to ammonia nitrogen during biological reactions, became a constraint for overall process operation. Also, there was a need for a multistage biological process for the conversion of all the TKN in the wastewater to nitrogen gas.

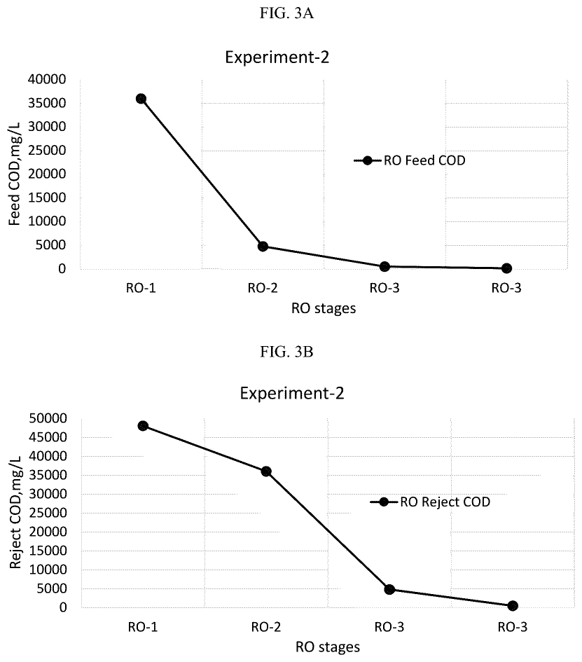

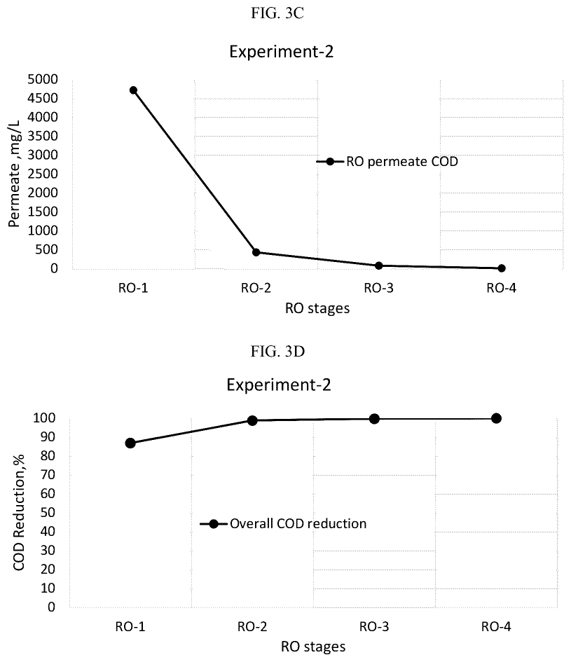

The TDS level of wastewater was low (about 160 mg/L), therefore, the wastewater was tested as per the scheme of the present invention to directly remove COD by using the RO membrane process for wastewater recycling and solvent recovery, and a further concentrated and low volume stream was thermally treated to recycle all water, and solids were sent to land filling. For Experiment-2, a BW membrane was used, and feed pressure was 4.0 kg/cm2, recognizing that other embodiments of the invention might contemplate use of 3.5 kg/cm2, or even 5.0 kg/cm2. The same flow scheme was followed as shown in FIG. 1B. In this particular case, the pH of the wastewater was 9.5 to 10, and the system was operated with the same pH, without any correction. Table 5 shows data on feed, permeate, and reject COD of each stage of RO process, while FIGS. 3A, 3B, 3C, and 3D show feed COD at each stage of RO, Reject COD after each stage of RO, permeate COD at each stage of RO and overall COD reduction respectively.

TABLE 4
Feed water characteristics of experiment 2

| SN | Parameter | UOM | Value |
|---|---|---|---|
| 1 | pH | — | 10.4 |
| 2 | Conductivity | μS/cm | 298 |
| 3 | Total Dissolved Solids (TDS) | mg/l | 160 |
| 4 | Chemical Oxygen Demand (COD) | mg/l | 4800 |
| 5 | Total Kjeldahl Nitrogen (TKN) | mg/l | 196 |
| 6 | Ammoniacal Nitrogen (NH3—N) | mg/l | 9.93 |
| 7 | Organic-solvents | mg/l | 4000 |

TABLE 5
COD data of experiment 2

| | COD analysis data (mg/L) | | | | |
|---|---|---|---|---|---|
| | | | | COD Reduction | Overall |
| Treatment | | | | across | COD |
| pass | Feed | Reject | Permeate | each stage | Reduction |
| RO-1 | 36000 | 48000 | 4720 | 87 | 86.88 |
| RO-2 | 4720 | 36000 | 430 | 91 | 98.8 |
| RO-3 | 430 | 4720 | 80 | 81 | 99.77 |
| RO-4 | 80 | 430 | 10 | 88 | 99.98 |

As shown in Table 5 and FIGS. 3A, 3B, 3C, and 3D, a gradual COD reduction was observed. The first stage shows maximum COD reduction, and it will get further improved in subsequent stages. Overall COD reduction was observed at >95% and closer to 99.5%. The RO membrane at each stage was observed to be performing well without an increase in differential pressure.

### Experiment-3

In a further effort to validate the application of the RO system, the next experiment was conducted at the actual site of the manufacturing facility on a larger scale. The same flow scheme was followed, as shown in FIG. 1B. The wastewater produced from the manufacturing industry was treated through a RO membrane process for wastewater recycling and solvent recovery system; the dilute stream was recycled back as process water, while the concentrated stream was taken through thermal treatment via advanced vacuum membrane distillation (AVMD), followed by an agitated thin film dryer (ATFD) to convert it into solids, which were further sent for disposal. Table 6 shows the average feed water quality entering the system.

TABLE 6
Feed water quality to RO system

| SN | Parameter | UOM | Value |
|---|---|---|---|
| 1 | pH | — | 9.1 |
| 2 | Conductivity | μS/cm | 2816 |
| 3 | Chemical Oxygen Demand (COD) | mg/l | 56145 |
| 4 | Total Kjeldahl Nitrogen (TKN) | mg/l | 5652 |

The water quality after each stage of the RO unit is shown in Table 7. This provides an overall picture of the process performance, right from the entry of feed water to the RO-1 stage and treated water coming out of the RO-5 stage.

TABLE 7
Summary of RO performance

| | pH | | EC (μS/cm) | | COD (mg/lit) | | | TKN (mg/lit) | | |
|---|---|---|---|---|---|---|---|---|---|---|
| Step | Feed | Prod. | Feed | Prod. | Feed | Prod. | Red. | Feed | Prod. | Red. |
| RO-1 | 9.05 | 9.40 | 2816.24 | 318.57 | 56145 | 14530 | 76.07 | 5652 | 1918 | 61 |
| RO-2 | 9.62 | 9.46 | 325.882 | 203.82 | 12162 | 3298 | 70.87 | 1549 | 567 | 64 |
| RO-3 | 9.53 | 9.19 | 215.685 | 131.28 | 2980 | 513 | 82.09 | 460 | 135 | 71 |
| RO-4 | 9.26 | 9.10 | 129.956 | 89.48 | 496 | 88.5 | 82.28 | 120 | 70.6 | 43 |
| RO-5 | 9.06 | 8.73 | 78.7697 | 60.43 | 89.1 | 6.97 | 92.91 | 80.8 | 10.17 | 75 |

As shown in Table 7, there was a 99.99% reduction in COD value and a 99.82% reduction in TKN after passing through all stages of RO. The treated water shows a COD of <10 mg/litre and a TKN value reduced to about 10 mg/litre. The overall treated water quality obtained from the system is shown in Table 8.

TABLE 8
Overall treated water quality

| SN | Parameter | UOM | Value |
|---|---|---|---|
| 1 | pH | — | 8.73 |
| 2 | Conductivity | μS/cm | 60.43 |
| 3 | Chemical Oxygen Demand (COD) | mg/l | 6.97 |
| 4 | Total Kjeldahl Nitrogen (TKN) | mg/l | 10.17 |

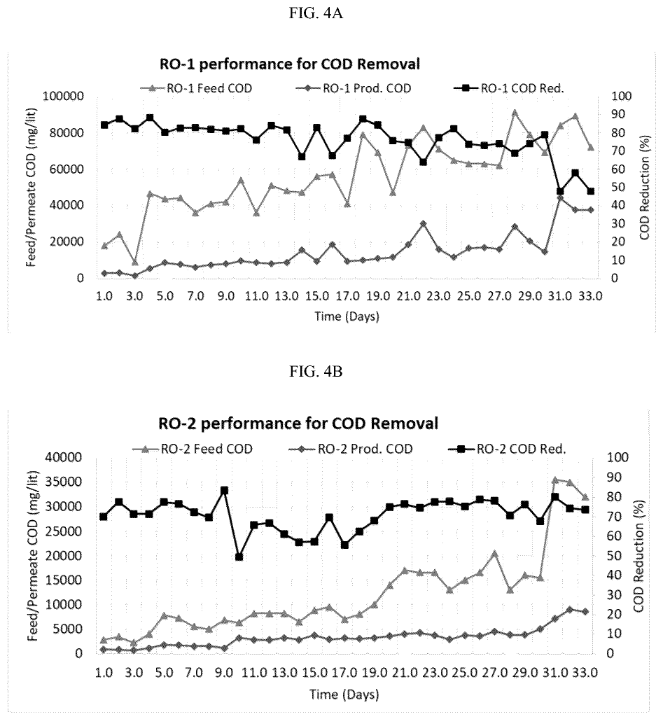

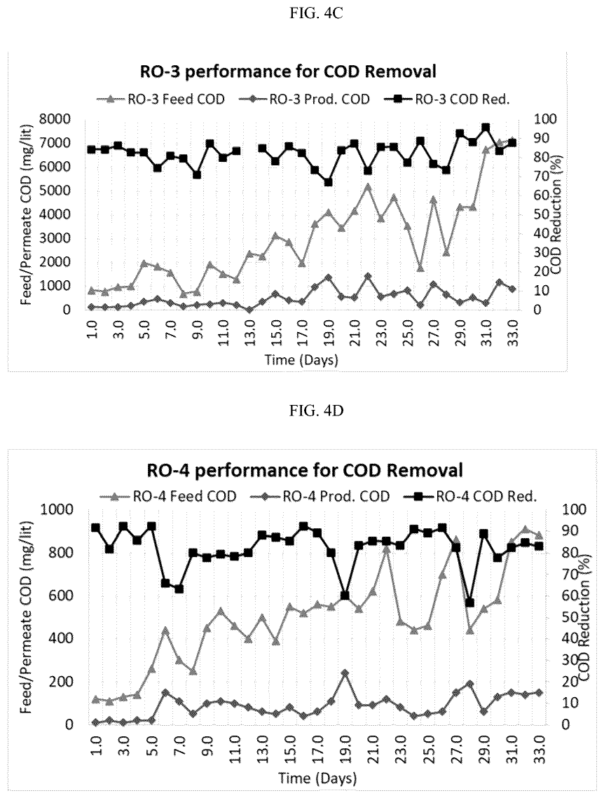

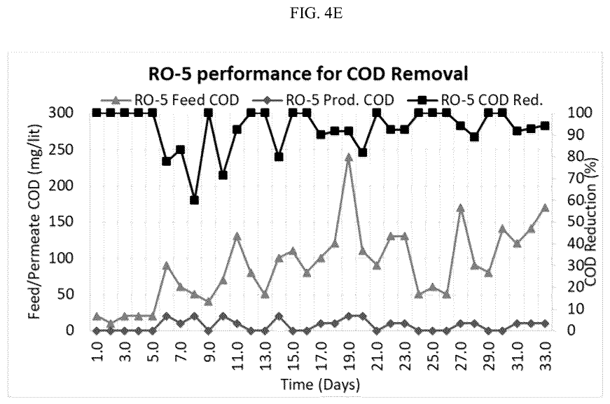

Each RO unit was observed to be performing for about 70-80% reduction; the concentrated stream that came out of the RO-1 unit had a maximum COD of 89,000 mg/litre. RO-1 unit performance for COD removal is shown in FIG. 4A.

The COD gets concentrated at the RO-1 stage, from which, after a certain time interval, a purge is provided, which takes a concentrated stream to pass through distillation unit by utilising processes like AVMD and ATFD.

The permeate stream further enters the RO-2 unit for further dilution of the COD from the water. The trend of COD reduction from RO-2 units is shown in FIG. 4B.

Further, as per the flow scheme, water kept passing through RO-3, RO-4, and RO-5, and at every stage, COD was reduced. Final water came out as RO-5 permeate was observed in ultimate diluted water, in which both COD and TKN were reduced to >99%. The trend of COD for RO-3, RO-4, and RO-5 is shown in FIGS. 4C, 4D, and 4E.

### CONCLUSION

Present innovations provide novel methods of treating solvent-rich wastewater or recovering solvent from the water. The experiments conducted showed that 99% COD rejection can be achieved by using multistage RO membrane process for wastewater recycling and solvent recovery. This made the treatment of waste stream possible with more than 90-95% recovery of water.

The concentrated water can be further treated for the separation of pure solvents with another method like distillation or pervaporation and cost effectively recover the solvent for beneficial use.

We claim:

1. A process for removing a solvent from water, comprising:
a. passing a feed water containing a solvent into a first reverse osmosis membrane water purification unit, and creating a first concentrated reject stream comprising the solvent and a first water permeate stream;
b. recycling the first concentrated solvent stream into the feed stream;
c. passing the first water permeate stream to a plurality of reverse osmosis membrane water purification units in a series, where each reverse osmosis membrane water purification unit in the series passes a water permeate stream to a successive feedwater for the next reverse osmosis membrane water purification unit in the series and passes a concentrated reject stream comprising solvent to a feed stream for the prior reverse osmosis membrane;
d. from a final reverse osmosis membrane water purification unit in the series, passing a final water permeate stream for collection or beneficial use, and, optionally polishing through an activated carbon filter; and
e. from the first reverse osmosis membrane water purification unit, purging the first concentrated reject stream.

2. The process of claim 1, wherein the solvent has a molecular weight above 50.

3. The process of claim 1, wherein the solvent is an organic solvent.

4. The process of claim 1, wherein the solvent is selected from the group consisting of N,N-dimethylacetamide, dimethylformamide, N-methyl-2-pyrrolidone, isopropyl alcohol, acetone, methyl chloride, chloroform, ethyl acetate, and combinations thereof.

5. The process of claim 1, further comprising pretreating the feed water through at least one of a nanofiltration membrane, microfiltration membrane, or ultrafiltration membrane prior to passing the feed water through the first reverse osmosis membrane water purification unit.

6. The process of claim 1, wherein each reverse osmosis membrane water purification unit is operated at a pH between 4 and 10.

7. The process of claim 1, further comprising maintaining feed water pH by adding acid or alkali.

8. The process of claim 1, comprising further processing the purged first concentrated stream by at least one of advanced vacuum membrane distillation to recover pure solvent or solvent containing some part of water for further purification and further treatment of the distillate bottom, if required, by agitated thin film drying to achieve further recovery and achieve Zero Liquid discharge.

9. The process of claim 8, wherein the further processing step achieves zero liquid discharge.

10. The process of claim 1, further comprising recovering solvent from the first concentrated reject stream following the purging of the first concentrated reject stream.

11. A process for removing a solvent from water, comprising:
a. pretreating a feed water containing a solvent in at least one of an ultrafiltration membrane, microfiltration membrane, or nanofiltration membrane;
b. passing the feed water into a first reverse osmosis membrane water purification unit, and creating a first concentrated reject stream comprising the solvent and a first water permeate stream;
c. recycling the first concentrated solvent stream into the feed stream;
d. passing the first water permeate stream to a plurality of reverse osmosis membrane water purification units in a series, where each reverse osmosis membrane water purification unit in the series passes a water permeate stream to a successive feedwater for the next reverse osmosis membrane water purification unit in the series and passes a concentrated reject stream comprising solvent to a feed stream for the prior reverse osmosis membrane;
e. from a final reverse osmosis membrane water purification unit in the series, passing a final water permeate stream for at least one of collection or beneficial use; and, optionally, passing the water stream for beneficial use through an activated carbon filter for polishing;
f. from the first reverse osmosis membrane water purification unit, purging the first concentrated reject stream;
g. optionally processing the purged first concentrated stream by at least one of advanced vacuum membrane distillation to further recover solvent, and optionally processing a distillate bottom from the advanced vacuum membrane distillation through agitated thin film drying for zero liquid discharge;
h. recovering solvent from the processed first concentrated reject stream for at least one of collection or beneficial use.

12. The process of claim 11, wherein the solvent has a molecular weight above 50.

13. The process of claim 1, wherein the solvent is an organic solvent.

14. The process of claim 1, wherein the solvent is selected from the group consisting of N,N-dimethylacetamide, dimethylformamide, N-methyl-2-pyrrolidone, isopropyl alcohol, acetone, methyl chloride, chloroform, ethyl acetate, and combinations thereof.

15. The process of claim 1, wherein each reverse osmosis membrane water purification unit is operated at a pH between 7 and 10.

16. The process of claim 1, further comprising maintaining feed water pH by adding acid or alkali.

17. The process of claim 8, wherein the further processing step achieves zero liquid discharge.
